(19) United States
(12) Patent Application Publication
(10) Pub. No.: US 2006/0004924 A1
(43) Pub. Date: Jan. 5, 2006

(54) Method and system providing support for location and service category service discovery in a SIP environment using a SIP event package, forking and AOR registration

(75) Inventor: Dirk Trossen, Cambridge, MA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/881,617

(22) Filed: Jun. 30, 2004

(51) Int. Cl. G06F 15/16

(52) U.S. Cl. 709/228; 709/227

(57) ABSTRACT

In one aspect this invention provides a method to operate an event notification system that includes at least one event server, at least one device and a subscriber unit. The method includes registering an Address of Record (AOR) of the device with a system registrar for each service category in which the device offers a service, the AOR being based on a service category naming convention; sending a Subscribe message from the subscriber unit to the device for registering to receive an availability notification for a desired service, the Subscribe message comprising a Uniform Resource Identifier (URI) based on the AOR service category naming convention. In response to a receipt of the Subscribe message, the method sends an initial Notify message from the device to the subscriber unit, the initial Notify message containing an indication of whether the desired service is currently supported by the device. Registering can further register a further AOR of the device with the system registrar for a location of the device, the further AOR being based on a location naming convention.

### CROSS-REFERENCE TO RELATED PATENT APPLICATIONS

This patent application is related to the following commonly assigned U.S. patent applications: D. Trossen, “Integration of Service Registration and Discovery in Networks”, Ser. No. 10/179,244, filed Jun. 26, 2002; D. Trossen, “Content and Service Registration, Query, and Notification using SIP Event Packages”, Ser. No. 10/330,146, filed Dec. 30, 2002; D. Trossen, K. Mehta, “Access Control Alert Method using SIP Event Package”, Ser. No. 10/353,014, filed Jan. 29, 2003; D. Trossen, “Querying for SIP Event Packages by Using SIP OPTIONS Method or by Using Service Discovery”, Ser. No. 10/418,313, filed Apr. 18, 2003; D. Trossen, D. Pavel, “Application Semantic Binding through SIP Event Package Template”, Ser. No. 10/465,455, filed Jun. 19, 2003; to U.S. patent application Ser. No. 10/______ filed ______, “Method, System and Computer Program to Enable Querying of Resources in a Certain Context by Definition of SIP Event Package”, by Dirk Trossen and Dana Pavel; and to U.S. patent application Ser. No. 10/______, filed ______, “Method, System and Computer Program to Enable Semantic Mediation for Sip Events Through Support of Dynamically Binding to and Changing of Application Semantics of Sip Events”, by Dirk Trossen and Dana Pavel, the disclosures of which are incorporated by reference in their entireties.

### TECHNICAL FIELD

This invention relates generally to wireless communications systems and methods and, more specifically, relates to wireless terminals and wireless network nodes that use a Session Initiation Protocol (SIP).

### BACKGROUND

The infrastructure of the Session Initiation Protocol (SIP) is defined in IETF RFC 3261 (Rosenberg et al., June 2002). In general, the SIP is an application-layer control (signaling) protocol for creating, modifying and terminating sessions with one or more participants. The sessions can include Internet telephone calls, multimedia distribution and multimedia conferences. SIP invitations used to create sessions carry session descriptions that allow participants to agree on a set of compatible media types. SIP makes use of elements called proxy servers to help route requests to the user's current location, authenticate and authorize users for services, implement provider call-routing policies and provide features to users. SIP also provides a registration function that allows users to upload their current locations for use by proxy servers. SIP runs on top of several different transport protocols.

In “SIP-Specific Event Notification”, A. Roach, RFC 3265, July 2002 (referred to hereafter simply as RFC 3265), there is described a SIP event framework to enable event-based information provisioning to any node in the Internet. This procedure is expected to become a key element within the SIP infrastructure. Examples of this kind of information are presence, location information, content/service availability, or access-controlled SIP events.

As is discussed in RFC 3265, the general concept is that entities in the network can subscribe to resource or call state for various resources or calls in the network, and those entities (or entities acting on their behalf) can send notifications when those states change. A typical flow of messages would be:

| Subscriber | Notifier |
|---|---|
| \|-----SUBSCRIBE---->\| | Request state subscription |
| \|<-------200--------------\| | Acknowledge subscription |
| \|<------NOTIFY---------\| | Return current state information |
| \|--------200------------->\| | Acknowledge |
| \|<------NOTIFY-------- \| | Return current state information |
| \|--------200------------->\| | Acknowledge |

Subscriptions are expired and must be refreshed by subsequent SUBSCRIBE messages.

Several useful definitions include the following:

AOR: Address of Record

Event Package: An event package is an additional specification which defines a set of state information to be reported by a notifier to a subscriber. Event packages also define further syntax and semantics based on the framework defined by RFC 3265 that are required to convey such state information.

Notification: Notification is the act of a notifier sending a NOTIFY message to a subscriber to inform the subscriber of the state of a resource.

Notifier: A notifier is a user agent which generates NOTIFY requests for the purpose of notifying subscribers of the state of a resource. Notifiers typically also accept

SUBSCRIBE requests to create subscriptions.

Subscriber: A subscriber is a user agent which receives NOTIFY requests from notifiers; these NOTIFY requests contain information about the state of a resource in which the subscriber is interested. Subscribers typically also generate SUBSCRIBE requests and send them to notifiers to create subscriptions.

Subscription: A subscription is a set of application state associated with a dialog. This application state includes a pointer to the associated dialog, the event package name, and possibly an identification token. Event packages will define additional subscription state information. By definition, subscriptions exist in both a subscriber and a notifier.

As was noted above, the SIP event framework defined in RFC 3265 is intended to enable event-based information provisioning to any node in the Internet. SIP events are used to provide a notification scheme that allows for conveying state changes of a particular resource, or changes of aggregated states relating to a pool of resources, to subscribers for the state information. Examples for this kind of information are presence (see J. Rosenberg, “A Presence Event Package for the Session Initiation Protocol (SIP)”, Internet Draft, Internet Engineering Task Force, (work in progress), January 2003), location information or content/service availability (see, for example, US 2004/0003058 A1, D. Trossen, “Integration of Service Registration and Discovery in Networks”, Ser. No. 10/179,244, filed Jun. 26, 2002). In these cases the resource is the presentity, the location information or the content/service information, and changes to these resources are conveyed to subscribers as event notifications.

An element of the SIP interactivity discussed briefly above is service discovery in SIP event environments. Discovery requests and service availability subscriptions are initiated for services within certain categories or locations. Newly available service agents are supported via registration subscriptions.

The approaches disclosed by the inventor in “Integration of Service Registration and Discovery in Networks”, Ser. No. 10/179,244, filed Jun. 26, 2002, and in “Content and Service Registration, Query, and Notification using SIP Event Packages”, Ser. No. 10/330,146, filed Dec. 30, 2002 are techniques to achieve service discovery and availability in SIP environments. In general, these techniques assume that the SIP event server is a dedicated discovery agent in the discovery environment. The system described by K. Arabshian, H. Schulzrinne, “GloServ: Global Service Discovery Architecture”, paper submission, Columbia University presents an approach for category-based and location-based service discovery in which services are grouped by category (such as “restaurant”) or civic location (such as “New York”), and allow for hierarchical searches by introducing appropriate Domain Name Service (DNS) naming schemes for the environment. This proposed system architecture requires the presence of a dedicated discovery agent.

The availability of SIP technology in many future devices makes it desirable to provide some type of service announcement scheme for services provided by these devices. Further, ordering services according to categories or location is desirable in many scenarios, such as in home environments (devices in certain location, such as living room). However, at least some of the systems mentioned above, as well as the one proposed by E. Guttman et al., “Service Location Protocol Version 2”, Internet Engineering Task Force, RFC 2165, June 1999, assume that a dedicated directory agent exists in the environment. However, the presence of such an agent introduces an additional component into the system that must be implemented and maintained, thereby increasing cost and complexity.

As for a SIP-based solution, it would be desirable to have such category-based/location-based discovery scheme with the same advantages as obtained by using the prior discovery techniques, including integration in SIP environments as well as support for availability notifications, in addition to the plain discovery, without requiring the introduction of a discovery agent as a dedicated element in the environment.

In general, the prior approaches typically rely on central discovery agents to exist in the discovery system, i.e., there is a dedicated element in the network, hosting the service information. This information is queried by user agents, and the results are retrieved. In the inventor's previous U.S. patent applications Ser. Nos. 10/179,244 and 10/330,146 a subscription model is offered that additionally allows for availability information of later published services.

In addition to the foregoing, schemes such as the one described by Yaron Y., Cai, Ting, Leach, Paul, Gu, Ye, and Albright, Shivaun, “Simple Service Discovery Protocol”, Work In Progress, IETF Draft, Oct. 28 1999, do not rely on a dedicated central entity, i.e., the discovery agent. However, they rely instead on the usage of multicast for relaying the discovery messages to every service agent. Since there usually do not exist different multicast groups for particular categories or locations, the discovery request is received by every service agent in the environment. As can be appreciated, this approach can place a heavy burden on the system, in particular with respect to scalability. Hence, this type of system is more optimally targeted at smaller environments, such as home environments, in which such scalability issues do not arise.

A need thus exists, but was not adequately fulfilled prior to this invention, to provide the application of SIP events for discovery/availability functionality, as well as for the support of newly available (newly registered) service agents. The more preferred solution would apply to the forking of subscriptions as defined in RFC 3265, where AORs may be grouped by service categories or locations, without requiring the introduction of a dedicated service discovery agent.

### SUMMARY OF THE PREFERRED EMBODIMENTS

The foregoing and other problems are overcome, and other advantages are realized, in accordance with the presently preferred embodiments of these teachings.

This invention solves the foregoing and other problems by providing in one aspect thereof a method to operate an event notification system that includes at least one event server, at least one device and a subscriber unit. The method includes registering an Address of Record (AOR) of the device with a system registrar for each service category in which the device offers a service, the AOR being based on a service category naming convention; sending a Subscribe message from the subscriber unit to the device for registering to receive an availability notification for a desired service, the Subscribe message comprising a Uniform Resource Identifier (URI) based on the AOR service category naming convention and, in response to a receipt of the Subscribe message, sending an initial Notify message from the device to the subscriber unit, the initial Notify message containing an indication of whether the desired service is currently supported by the device. Registering can further register a further AOR of the device with the system registrar for a location of the device, the further AOR being based on a location naming convention.

In a further aspect this invention provides a device having an interface to a SIP proxy. The device has a controller operable for registering an AOR of the device with the SIP proxy for each service category in which the device offers a service, the AOR being based on a service category naming convention and uses a device Uniform Resource Identifier (URI) as a contact URI. The controller is responsive to a receipt of a Subscribe message originated from a subscriber for subscribing to an “Availability” event package for returning an initial Notify message containing an indication of whether a service is currently available at the device, where the service is specified in the Subscribe message, and if the Subscribe message indicates a non-zero lifetime, for returning a subsequent Notify message in the event that there is a change in the availability of the desired service at the device. The controller may also register a further AOR of the device for indicating a location of the device, the further AOR being based on a location naming convention. In this case the controller can return the initial Notify message to contain an indication of the location of the device, where the location is specified in the Subscribe message.

In a still further aspect this invention provides a domain registrar associated with a SIP proxy for managing registration of at least an AOR of devices associated with a domain, where each AOR includes at least one of an indication of a service provided by the device or a location of the device, in accordance with at least one of an AOR service and location naming protocol. The domain registrar is responsive to a receipt of a Subscribe message from a subscriber for subscribing to the registration state of at least one of the registered AORs, for returning an initial Notify message to the subscriber for indicating a current registration state of the at least one of the AORs, and for returning a subsequent Notify message to the subscriber in response to a change in state of the at least one of the AORs.

In a still further aspect this invention provides a subscriber unit operable in an event notification system, and containing logic to originate a Subscribe message to subscribe to a service “Availability” event package. The logic is responsive to a receipt of an initial Notify message to determine whether a desired service is currently available at a device or devices, where the desired service is specified in the Subscribe message, and if the Subscribe message is originated with a non-zero lifetime indication, to receive a subsequent Notify message in the event that there is a change in the availability of the desired service at the device or devices.

In a yet still further aspect this invention provides a subscriber unit operable in an event notification system, and containing logic to originate a Subscribe message to a SIP proxy that manages registration of at least an AOR of devices associated with a domain. Each AOR includes at least one of an indication of a service provided by the device or a location of the device, in accordance with at least one of an AOR service and location naming protocol. The Subscribe message is for subscribing to a registration state of at least one of the registered AORs. The subscriber unit is responsive to a receipt of an initial Notify message to determine a current registration state of the at least one of the AORs, and to a receipt of a subsequent Notify message to determine a change in state of the at least one of the AORs.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows the overall architecture and major logical entities of the present invention;

FIG. 2 illustrates various process steps and messages in accordance with a discovery process in accordance with the invention; and

FIG. 3 shows various process steps and messages in response to a change in the environment.

### DETAILED DESCRIPTION OF THE PREFERRED EMBODIMENTS

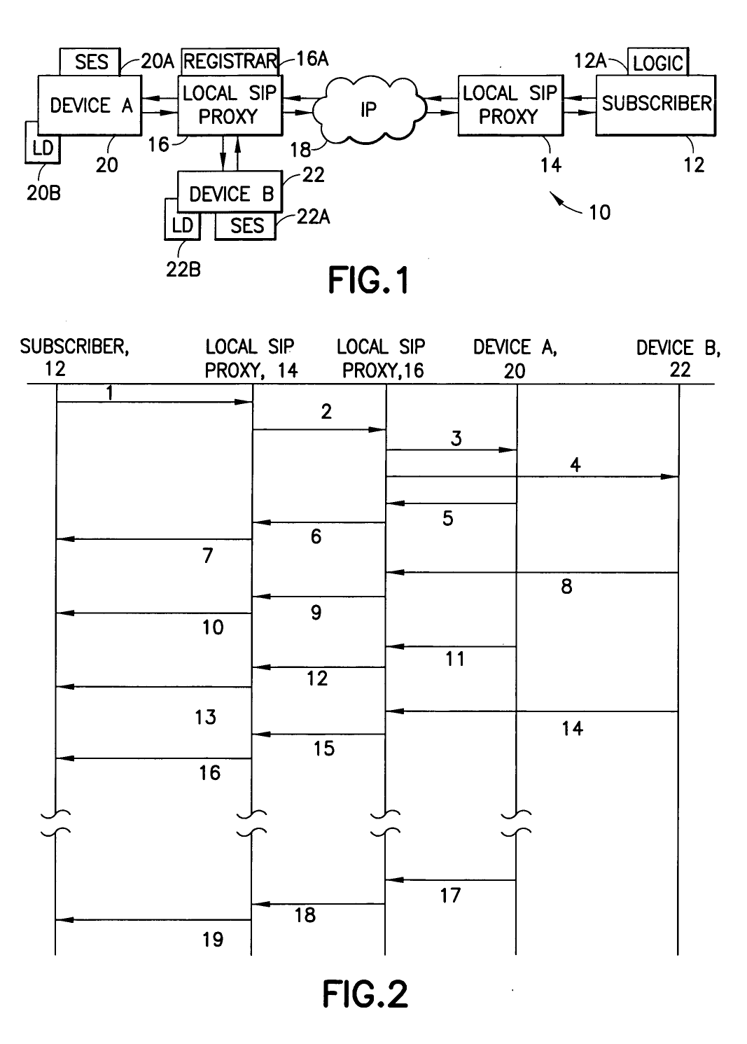

The presently preferred embodiment of this invention describes the system and method in the overall context of the SIP event framework, as defined by RFC 3265. Hence, the operation of the event server and subscriber unit described below with respect to FIG. 1 is based on the SIP event framework. However, the use of the SIP event framework is not to be construed as a limitation upon the practice of this invention.

Referring to FIG. 1 there is shown a simplified architectural diagram of a system 10 that is suitable for practicing this invention. The system 10 includes a subscriber 12, local SIP proxies 14 and 16, a network such as an Internet Protocol (IP) network 18 and a plurality of devices (e.g., two devices: DEVICE_A 20, DEVICE_B 22) connected to the IP network 18 via the SIP proxy 16.

In the presently preferred, but non-limiting embodiment of this invention the subscriber 12 is associated with a mobile wireless communications device, such as a cellular telephone, or a personal communicator, or a mobile user or agent such as a computer that is coupled to the network 18 via a wireless link. The network 18 can comprise the Internet.

The subscriber 12 includes logic 12A and is assumed to desire to discover the availability of services or content, as described in further detail below.

The SIP proxies 14 and 16 typically exist for the subscriber 12 as well as for the devices 20, 22, and are responsible for the handling of SIP messages and appropriately forwarding the SIP messages to the specified entity. Note that the SIP proxies 14 and 16 represent a non-limiting embodiment of an entity that provides forwarding of registration, subscription, and notifications, as provided by the SIP event framework specified by RFC 3265. However, other mechanisms could be used as well in other embodiments of this invention. Thus, while the SIP proxies 14, 16 are a presently preferred embodiment, their use should not be construed as a limitation upon the implementation and practice of this invention.

The various logic units, functions and modules that comprise the subscriber 12 and devices 20, 22 can be constructed using hardware, software or a combination of hardware and software. In some cases the logic units, functions and modules can be implemented in whole or in part with computer program code that is locally stored and executed by data processors that comprise the subscriber unit 12 and the devices 20, 22, as well as the SIP proxies 14, 16.

By way of introduction, the invention has three major components or functions, namely registration, subscription, and reaction to changes.

The registration function assumes the presence of a user naming scheme that defines a hierarchy of service categories and locations. The above mentioned K. Arabshian, H. Schulzrinne, “GloServ: Global Service Discovery Architecture”, paper submission, Columbia University, provides an example of such naming scheme. Hence, a hierarchy of categories and locations is assumed, such as “service.CE.cablebox” or “location.us.NY.new_york”. This user naming scheme is combined with the domain information as the service agent's AOR to be used in its registration with the SIP system 10. Hence, a cable box (e.g., Device_A 20 in FIG. 1) in a living room registers two AORs with SIP, namely “sip:location.livingroom@domain” and “sip:service.CE.cablebox@domain”, each registration using the service agent's contact address in its registration. The settings for such AORs can be done, for example, via an appropriate user interface when powering up the devices for the first time (during initial configuration).

Note that the actual naming scheme may be subject to standardization in appropriate standardization bodies. For example, the Universal Plug and Play (UPnP™) forum is one possible candidate for such name standardization within a home environment.

The subscription is based on a SIP event package, named “availability”, according to RFC3265. The request Uniform Resource Identifier (URI) for each subscription, sent by a particular user agent, is one of the AORs based on the naming scheme explained above. For instance, a user agent may subscribe to an event at request URI “sip:location.livingroom@domain”. According to RFC3265 the event package specifically supports forking of subscriptions. Due to the multiple AOR registrations of all devices 20, 22 in the living room, and the forking capabilities of the event package, the subscription is forked to all registered devices in the living room, constituting therefore a location-based discovery (the same occurs for discovery within categories, such as within “cable box”). The particular registered device 20, 22 receives the subscription as a SIP event server, delivering the matching service parameters back to the subscriber 12.

It is noted that after local matching services become available, the device 20, 22 will notify the subscriber 12 appropriately, according to RFC3265, thereby providing a service availability notification.

A user can react to changes in the environment by subscribing to a registration state for a particular AOR according to, for example, J. Rosenberg, “Registration State Event Package”, Work In Progress, IETF Draft, 2003. A notification for such a state constitutes a change in environment, such as the removal or addition of a device 20, 22 in a particular location or category. The subscriber 12 may react to this change with a subscription to the particular location or category. In the case of an existing subscription, the subscription is renewed, automatically forking the subscription to the newly added device 20, 22. In the case of a removal, a current subscriber to the removed device can initiate appropriate actions, such as choosing an appropriate replacement for the removed device.

In accordance with an aspect of this invention, an inter-domain discovery process is supported by subscribing to the particular AOR in the particular domain, e.g., a user in enterprise A can subscribe to “sip:service.projectors@enterpriseB.com” to determine information concerning the projector equipment in enterprise B. Access authorization policy approaches, such as XCAP (an Extended Mark-up Language (XML)-based Configuration Access Protocol) can be used to restrict access for visitors in order to the preserve privacy of the service data (e.g., the user in enterprise A may only discover the projector equipment in Enterprise B if duly authorized to do so).

In the system 10 of FIG. 1 it is assumed that the subscriber 12 desires to subscribe to the availability of a particular service within a certain category or location. Device_A 20 and Device_B 22, implement particular services and include SIP event server (SES) logic 20A, 22A, respectively. The SIP event servers 20A, 22A are deemed to be compliant with RFC3265 (in this non-limiting but presently preferred embodiment of this invention). In order to implement the present invention, the SIP event servers 20A, 22A include, apart from the functionality compliant with RFC3265, support for the Event Package described below that provides notifications on availability of services. Further, the devices 20, 22 register their contact address under the AOR naming scheme described below. Although shown in FIG. 1 as being registered to a single SIP proxy 16, the Device_A 20 and Device_B 22 may also be registered to different SIP proxies, as in an inter-domain discovery scenario.

The SIP proxies 14, 16 exist for the subscriber 12 and the Device_A 20 and Device_B 22 (possibly different for each) and are responsible for the handling of SIP messages, such as by appropriately forwarding them to the specified entity. Note that in the exemplary home environment scenario, the SIP proxy for the subscriber 12 and for Device_A 20 and Device_B 22 would typically be the same (i.e., the subscriber 12 and the Device_A 20 and Device_B 22 would all be connected to the same SIP proxy).

An aspect of this invention is the definition of an event package (compliant to RFC3265) that is referred to for convenience, and not by way of limitation, as “Availability”. The characteristic (or description) of the service is included in the body of the subscription or notification. RDF and XML are both suitable candidates for use in describing the service.

According to RFC3265 the event package explicitly supports forking of subscriptions with the request URI being the destination of the event subscription, i.e., the AOR of the SIP event server.

In accordance with a further aspect of this invention there is a naming scheme for the device 20, 22 AORs that is based preferably on a category and location hierarchy. K. Arabshian, H. Schulzrinne, “GloServ: Global Service Discovery Architecture”, paper submission, Columbia University, gives an example for such hierarchy. For example, AORs can be constructed such as:

“sip:location.livingroom@myhome.com” can be used for location-based registration; or “sip:service.cablebox@myhome.com” can be used for category-based registration. Hierarchies as outlined by K. Arabshian et al. can be constructed as well, thereby implying recursive application of this invention, e.g., registration and subscription to upper and lower hierarchy AORs, respectively. However, for the sake of simplicity, the ensuing description assumes the use of a flat hierarchy, as such a flat hierarchy is very likely to be present in small, contained environments such as home environments.

Each device 20, 22 in a particular SIP environment needs to register to the SIP environment, according to J. Rosenberg et al, “SIP: Session Initiation Protocol”, RFC 3261, July 2002. In order to be discovered as a service agent in the SIP environment, the device 20, 22 additionally registers, according to RFC3261, within each service category in which it offers services. Further, it is possible to register based on its location, if such information is available. While the category (e.g., projector, or cable box) is usually known to the device 20, 22, the location may be entered during the initial configuration of the device, using a user interface (e.g., location=Conference Room A, or Living Room). It is also possible to use automatic means of determining the location, such as indoor location beacons or RFID tags, and thus the devices 20, 22 may each include some type of location determination (LD) device or function 20B, 22B.

During the registration of the device 20, 22 as a service agent, the different AORs (for each supported service category and the location) are registered with the local SIP proxy (e.g., 16 in the case of FIG. 1). The device URI is given within each registration as the contact URI.

For example, a cable box in the living room with URI “sip:pc27@myhome.com” would register two AORs, namely:

“sip:location.livingroom@myhome.com” for location-based registration, and “sip:service.cablebox@myhome.com” for category-based registration, with “sip:pc27@myhome.com” as the contact URI, according to RFC3265.

Note that, in order to be reachable, the device 20, 22 would also register its own AOR with the SIP system. However, this registration is not germane to an understanding of this invention.

A description is now made of the discovery request and availability subscription aspects of this invention.

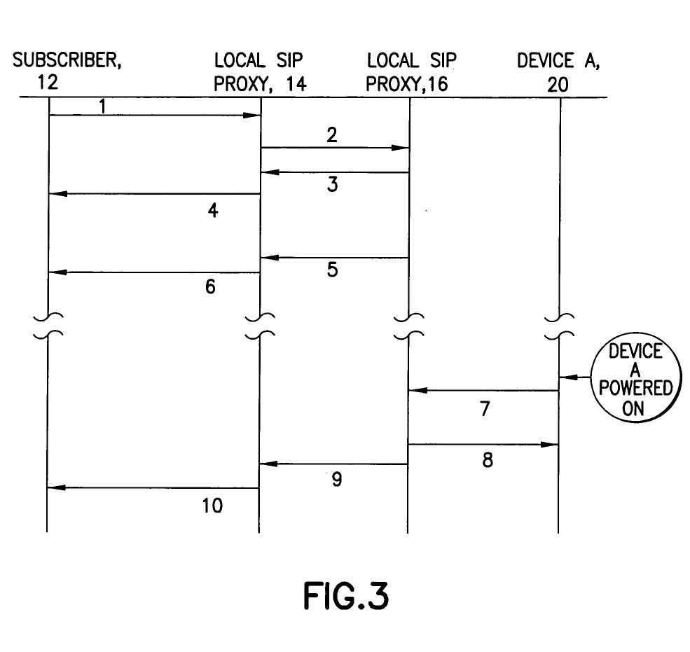

FIG. 2 shows the steps and messages that are used, in accordance with this invention, for subscribing to the availability of services at particular devices. The subscriber 12 first selects an appropriate request URI for the subscription. This request URI is based on the naming scheme explained above, and reflects the subscriber's interest in services either within particular categories or locations. For example, the subscriber 12 may select a request URI: “sip:location.livingroom@myhome.com” for service discovery among devices 20, 22 in the living room.

The subscriber 12 sends a SUBSCRIBE (message 1 in FIG. 2, routed via the SIP proxies 14, 16 as message 3 to Device_A 20 and message 4 to Device_B 22) to the event “availability”, directed towards the chosen request URI. The body of the subscription includes an appropriate description of the service the subscriber 12 is interested in.

It is assumed that Device_A 20 and Device_B 22 in FIG. 1 have registered under the chosen request URI, i.e., they are devices located in the living room.

Since both devices, Device_A 20 and Device_B 22, registered the chosen request URI as their AOR, the subscription requests are forked, according to RFC3261 and RFC3265, and sent to both devices 20 and 22 (shown as messages 3 and 4 in FIG. 2).

According to RFC3265, the Device_A 20 and Device_B 22, acting as SIP event servers 20A, 22A, respond with an Acknowledgment as to whether the subscription is granted. Such a decision may be based on the support of the event, or the access rights of the subscriber 12. With the latter, the privacy of the service data is preserved, in particular for scenarios in which visitors have access to the service data, either locally (visitor scenarios in local environments) or remotely (potential visitor in domain A desires to find services in domain B). For such access rights support, existing access authorization policies may be used.

Device_A 20 and Device_B 22 both respond according to RFC3261 and RFC3265 with a reason code (‘200OK’ if accepted), shown as message 5 and message 8 in FIG. 2 (routed via the SIP proxies 14, 16 as messages 6,7 and 9,10). If the subscriptions have been granted, Device_A 20 and Device_B 22 respond, according to RFC3265, with an initial NOTIFY (shown as messages 11 and 14 in FIG. 2, routed via the SIP proxies 14, 16 as messages 12, 13 and 15,16 to the subscriber 12). The bodies of the NOTIFY messages contain descriptions of the services that match the subscription request. If there is no match at Device_A 20 or Device_B 22, the respective notification message contains an empty (null) body portion.

Note that due to the concurrent character of the message delivery in the Internet 18, the message sequence in FIG. 2 with respect to Device_A 20 and Device_B 22 can be other than as shown. In other words, the temporal order of the messages can be different due to the typical delays in message delivery that can be experienced through the Internet.

If the subscription has been a “one-shot” subscription according to RFC3265, i.e., its lifetime has been defined as zero in the subscription request, the steps described above can be seen to constitute a simple discovery request. Hence, there is no subscription established at the SIP event servers 20A, 22A of Device_A 20 and Device_B 22, respectively.

However, in the case where the lifetime of the subscription request is defined as non-zero, a proper subscription is set-up at the SIP event servers 20A, 22A, according to RFC3265. With this subscription, if the service availability at any of the subscribed devices 20, 22 changes in the future, the SIP event server 20A, 22A of the affected device 20, 22 matches the newly available service with the existing subscriptions. If a match is found to exist, an appropriate notification is sent to the subscriber 12. This is shown in FIG. 2 for the case that such match has been found at Device_A 20 (showing the NOTIFY as message 17, routed as messages 17, 18 via the SIP proxies 14, 16 and delivered as message 19 to the subscriber 12). The body of the NOTIFY contains the description of the newly available service.

With these steps, the subscriber 12 obtains knowledge of available services in a particular category or location, expressed through the particularly selected AOR.

It is often the case that environments that include service-providing devices, such as the devices 20 and 22 in FIG. 1, can change over time. For example, devices can be powered off for energy saving reasons (such as consumer electronic devices), they can fail, or they can be reconfigured or simply moved. Relatedly, the availability of services provided by devices can change over time as well. Either the availability as such can change (no longer available after the device has been switched off), the location of the device can change (by moving a DVD player or a VCR to another room), or the category can change due to a reconfiguration.

The preferred embodiment of this invention accommodates such changes in the manner described below.

The devices 20, 22 in the SIP environment register with the local SIP proxy 16 when powered on (and time out when they are powered off). Further, as explained above, the registered AOR constitutes the service category and location of the device.

Hence, a subscriber (which is not necessarily the same subscriber that subscribes to the services as in FIG. 2) can subscribe to the registration state of a particular AOR. One suitable technique for performing this subscription function is described by J. Rosenberg, “Registration State Event Package”, Work In Progress, IETF Draft, 2003. This process is shown in FIG. 3. In this exemplary sequence it is assumed that Device_A 20 is powered on at a particular point in time.

The subscriber 12 sends a SUBSCRIBE to the registration state (message 1 in FIG. 3) to the local SIP proxy 16 (message 2 in FIG. 3) of the particular domain. In practice, the subscription is sent to the registrar of the domain, which is typically co-located with the SIP proxy 16 (shown as registrar 16A in FIG. 1). The signaling diagram of FIG. 3 assumes for simplicity that the domain registrar is co-located with the SIP proxy 16. The request URI of the subscription is the AOR of the particular service category or location of interest. In this example the subscriber 12 may select: “sip:location.livingroom@myhome.com” in order to be notified about changes in the subscriber's living room.

After accepting the subscription (otherwise, an error code is returned according to RFC3265), the registrar 16A of the SIP proxy 16 responds with a ‘2000K’ back to the subscriber 12 (message 3 in FIG. 3, routed as message 4 to the subscriber 12).

According to RFC3265, the registrar 16A of the SIP proxy 16 sends an initial NOTIFY to the subscriber 12 (message 5 in FIG. 3, routed to the subscriber 12 as message 6). This NOTIFY message includes the registration state for the particular AOR, and may comply with J. Rosenberg, “Registration State Event Package”, Work In Progress, IETF Draft, 2003.

If Device_A 20 is subsequently powered on at some point in time, it performs the registration steps explained above, shown as message 7 and message 8 in FIG. 3, i.e., Device_A 20 registers itself, in accordance with an aspect of this invention, under the particular AOR that reflects it location and service category. Since the registered location AOR of Device_A 20 is: “sip:location.livingroom@myhome.com”, the SIP proxy 16 domain registrar 16A triggers a notification for the subscription of subscriber 12. Hence, the registrar sends a NOTIFY (message 9 in FIG. 3, sent as message 10 to the subscriber 12), which includes in its body the registration state for the AOR, which may be formatted and sent according to J. Rosenberg, “Registration State Event Package”, Work In Progress, IETF Draft, 2003. From this information, the subscriber 12 can extract from the body of the NOTIFY message the information regarding Device_A 20, and can further send a subscription (or renew an existing subscription) according to the steps explained above.

Note that also powering off a device may beneficially trigger a notification if a subscriber had subscribed to the state of the device. This notification would indicate the removal of the device. In this manner the preferred embodiments of this invention are enabled to cope with changes in the SIP environment.

Based on the foregoing description it should be apparent that an advantage of the use of the preferred embodiments of this invention is the removal of a dedicated discovery agent from the system 10, without also requiring the introduction of a multicast-based system. This is preferably achieved by using the service category and location AORs in a defined naming scheme, with the support of the forking of SIP event subscriptions. The system in accordance with the invention readily integrates into the existing SIP framework, i.e., no changes are required apart from standardizing the naming scheme and the event package according to the preferred embodiments of this invention.

Another advantage is that the preferred embodiments of this invention easily enable remote service discovery by simply subscribing to AORs in foreign domains. Existing access authorization policies can be used to securely reveal service data in such cases.

The preferred naming scheme defines the granularity of service categories and therefore defines a design parameter for the scalability of the approach, together with the general local character of the invention (since the registrations happens at the local SIP proxies, this allows for spreading the load among different SIP proxies).

For a case where category-based discovery may lead to requests sent to devices that do not necessarily provide matching services, finer-grained naming hierarchies can be employed, possibly in conjunction with recursive application of the invention.

In accordance with exemplary embodiments of this invention the problems present in the prior art are solved by applying category and location-derived AOR registration of devices, and the forking of discovery subscriptions to the contact addresses for a particular AOR (for a particular category or location). The exemplary embodiments of this invention additionally provide a system and method that notify interested parties of newly available service agents in particular categories or location, and accommodate variability in the SIP environment.

Furthermore, the combination of the exemplary embodiments of this invention with a naming scheme similar to the one described in K. Arabshian et al. would permit for hierarchical discovery to occur.

The exemplary embodiments of this invention enable location-based discovery through simple static configuration of service agents, and also allow for automatic determination of location information.

Further, the exemplary embodiments of this invention readily allow for foreign domain service discovery, assuming an adoption (e.g., through standardization) of the naming scheme for the service categories and locations, by simply subscribing to foreign domain AORs. Existing access authorization policy approaches (such as XCAP) can be used to control access to these services from foreign domains.

The foregoing description has provided by way of exemplary and non-limiting examples a full and informative description of the best method and apparatus presently contemplated by the inventor for carrying out the invention. However, various modifications and adaptations may become apparent to those skilled in the relevant arts in view of the foregoing description, when read in conjunction with the accompanying drawings and the appended claims. As but some examples, the use of other similar or equivalent message type and formats, resources and network architectures, may be attempted by those skilled in the art. However, all such and similar modifications of the teachings of this invention will still fall within the scope of this invention.

Furthermore, some of the features of the exemplary embodiments of this invention could be used to advantage without the corresponding use of other features. As such, the foregoing description should be considered as merely illustrative of the principles of the present invention, and not in limitation thereof.

What is claimed is:

1. A method to operate an event notification system comprising at least one event server, at least one device and a subscriber unit, comprising:
registering an Address of Record (AOR) and a contact address of the device with a system registrar for each service category in which the device offers a service, the AOR being based on a service category naming convention;
sending a Subscribe message from the subscriber unit to the device for registering to receive an availability notification for a desired service, the Subscribe message comprising a Uniform Resource Identifier (URI) based on the AOR service category naming convention; and
in response to a receipt of the Subscribe message, sending an initial Notify message from the device to the subscriber unit, the initial Notify message comprising an indication of whether the desired service is currently supported by the device.

2. A method as in claim 1, where the Subscribe message comprises a zero lifetime, and functions as a service discovery request message.

3. A method as in claim 1, where the Subscribe message comprises a non-zero lifetime, and further comprising establishing a subscription for the subscriber, and sending a further Notify message to the subscriber when the desired service becomes available.

4. A method as in claim 1, where registering further registers a second AOR of the device with the system registrar for a location of the device, the further AOR being based on a location naming convention.

5. A method as in claim 4, where the Subscribe message sent from the subscriber unit to the device registers to receive an availability notification for service provided by devices at a specified location, where the Notify message includes an identification of services provided by devices at the specified location, and where the Subscribe message comprises a non-zero lifetime, further comprising establishing a subscription for the subscriber, and sending a further Notify message to the subscriber when the availability of services provided by devices at the specified location changes.

6. A method as in claim 1, where the event notification system comprises a part of a Session Initiation Protocol (SIP) system, and where the Subscribe and Notify messages are SIP-compliant.

7. A method as in claim 1, where registering makes use of a registration function that comprises a naming scheme defining a hierarchy of service categories and locations.

8. A method as in claim 7, where a registering device registers at least two AORs, one AOR comprising a service category of the device and the contact address, and a second AOR comprising a location of the device and the contact address.

9. A method as in claim 8, further comprising subscribing to a registration state for a particular AOR, and receiving a notification based on at least one of an addition or a deletion of a device in a specific service category or location.

10. A method as in claim 8, where the location is provided by at least one of a user entering the location and a location sensor associated with the device.

11. A method as in claim 1, where the event notification system comprises a part of a Session Initiation Protocol (SIP) system, where the Subscribe and Notify messages are SIP-compliant, and where a subscription is based on a SIP availability event package that supports forking the subscription to a plurality of registered devices in at least one of a common AOR-defined service category and a common AOR-defined location, thereby providing device discovery within a service category or a location.

12. A method as in claim 1, where the Subscribe message is forked to a plurality of devices within a common domain.

13. A method as in claim 1, further comprising responding immediately to the Subscribe message by providing matching service parameters that are available, or responding to the Subscribe message at a later time when the matching service parameters become available.

14. A method as in claim 1, where the event notification system comprises a part of a Session Initiation Protocol (SIP) system, and the Subscribe message is sent to a SIP Proxy that is coupled between the device and an Internet Protocol network.

15. A device comprising an interface to a session initiation protocol (SIP) proxy, said device comprising a controller for registering an Address of Record (AOR) of the device with the SIP proxy for each service category in which the device offers a service, the AOR being based on a service category naming convention and using a device Uniform Resource Identifier (URI) as a contact URI, said controller being responsive to a receipt of a Subscribe message originated from a subscriber for subscribing to an “Availability” event package for returning an initial Notify message containing an indication of whether a service is currently available at the device, where the service is specified in the Subscribe message, and if the Subscribe message indicates a non-zero lifetime, for returning a subsequent Notify message in the event that there is a change in the availability of the desired service at the device.

16. A device as in claim 15, where said controller also registers a further AOR of the device for indicating a location of the device, the further AOR being based on a location naming convention, and where said controller returns the initial Notify message to contain an indication of whether a service is currently available at the device in a particular location, where a service is specified in the Subscribe message, and if the Subscribe message indicates a non-zero lifetime, for returning a subsequent Notify message in the event that there is a change in the availability of services provided by the device.

17. A device as in claim 15, where there are a plurality of devices associated with a domain, and where the Subscribe message is forked so that it is received by the plurality of devices.

18. A domain registrar associated with a Session Initiation Protocol (SIP) proxy for managing registration of at least an Address of Record (AOR) of devices associated with a domain, each AOR including at least one of an indication of a service provided by the device or a location of the device, in accordance with at least one of an AOR service and location naming protocol, said domain registrar being responsive to a receipt of a Subscribe message from a subscriber for subscribing to the registration state of at least one of the registered AORs, for returning an initial Notify message to the subscriber for indicating a current registration state of the at least one of the AORs, and for returning a subsequent Notify message to the subscriber in response to a change in state of the at least one of the AORs.

19. A subscriber unit operable in an event notification system, comprising logic to originate a Subscribe message to subscribe to a service “Availability” event package, said logic being responsive to a receipt of an initial Notify message to determine whether a desired service is currently available within a domain, where the desired service is specified in the Subscribe message using an Address of Record (AOR) naming convention, and for a Subscribe message that is originated with a non-zero lifetime indication, to receive a subsequent Notify message in the event that there is a change in the availability of the desired service within the domain.

20. A subscriber unit as in claim 19, where the event notification system comprises a part of a Session Initiation Protocol (SIP) system, and where the Subscribe and Notify messages are SIP-compliant.

21. A subscriber unit as in claim 19, where the subscriber unit comprises a mobile wireless communications device.

22. A subscriber unit operable in an event notification system, comprising logic to originate a Subscribe message to subscribe to a service “Availability” event package, said logic being responsive to a receipt of an initial Notify message to determine availability of services at a location, where the location is specified in the Subscribe message using an Address of Record (AOR) naming convention, and for a Subscribe message that is originated with a non-zero lifetime indication, to receive a subsequent Notify message in the event that there is a change in the services available at the location.

23. A subscriber unit as in claim 22, where the event notification system comprises a part of a Session Initiation Protocol (SIP) system, and where the Subscribe and Notify messages are SIP-compliant.

24. A subscriber unit as in claim 22, where the subscriber unit comprises a mobile wireless communications device.

25. A subscriber unit operable in an event notification system, comprising logic to originate a Subscribe message to a Session Initiation Protocol (SIP) proxy that manages registration of at least an Address of Record (AOR) of devices associated with a domain, each AOR including at least one of an indication of a service provided by the device or a location of the device, in accordance with at least one of an AOR service and location naming protocol, said Subscribe message for subscribing to a registration state of at least one of the registered AORs, said subscriber unit being responsive to a receipt of an initial Notify message to determine a current registration state of the at least one of the AORs, and to a receipt of a subsequent Notify message to determine a change in state of the at least one of the AORs.

26. A subscriber unit as in claim 25, where the subscriber unit comprises a mobile wireless communications device.
